(19) United States
(12) Patent Application Publication
(10) Pub. No.: US 2022/0309083 A1
(43) Pub. Date: Sep. 29, 2022

(54) SYSTEM, METHOD AND/OR COMPUTER READABLE MEDIUM FOR CROWDSOURCED/DISTRIBUTED AND VISUAL DATA INTEGRATION AND WORKFLOW AUTOMATION ACROSS MULTIPLE VISUAL LAYERS USING A MAP OR IMAGE AND SPATIAL INFORMATION

(71) Applicant: Premise HQ SAAS Inc., Toronto (CA)

(72) Inventor: Rafi Ud DOWLA, Toronto (CA)

(73) Assignee: Premise HQ SAAS Inc., Toronto, ON (CA)

(21) Appl. No.: 17/766,610

(22) PCT Filed: Oct. 8, 2020
(86) PCT No.: PCT/CA2020/051353

§ 371 Date: Apr. 5, 2022

Related U.S. Application Data
(60) Provisional application No. 62/912,097, filed on Oct. 8, 2019.

(51) Int. Cl. G06F 16/28; G06F 16/25

(52) U.S. Cl. CPC G06F 16/288; G06F 16/258; G06Q 50/16

(57) ABSTRACT

Disclosed is a system, method and/or computer readable medium that relates to an application for data integration. Layers of data are used to construct one above another and any layer can have a relationship with another layer in perspective of the measured space. Resolving the relationship between multiple layers or from one seemingly unrelated data layer to another becomes very easy. As a visual approach it can be used by end users to define relationship and highly accurate zoned data can be crowdsourced from multiple different organization and immediately integrated with other sourced data without needing any developer or manual data integration effort.

### CROSS-REFERENCE TO RELATED APPLICATIONS

This is a national phase entry of PCT Patent Application No. PCT/CA2020/051353 filed on Oct. 8, 2020, which claims priority to the U.S. provisional application 62/912,097 filed on Oct. 8, 2019, both of which are incorporated by reference herein.

### TECHNICAL FIELD

The present invention relates generally to a relational, non-relational and/or database system. In particular, the present invention relates to a system, method and/or computer readable medium for the integration of data from different databases and application of the relationships identified from the integration with respect to a predetermined space and/or image.

### BACKGROUND

In the prior art, data is typically siloed and generated by multiple and/or varied sources, which may include internal and/or external sources. This situation may apply to the real estate industry or any industry that uses data that relates to a space or image. For example, the situation can become complex when attempting to associate building system and/or sensor data with business process data or data generated by a human process (e.g., inspections), which may be presented as layers of information that relate to different locations and/or zones within a measured space (e.g., a floor in a building). When performed using a traditional database, translating the zone concept to the traditional database (e.g., relational, No SQL, Graph) may be limiting as the layers and/or zones may have partial relationships with other layers and/or zones and the cross-section of multiple layers can have different implications for the building itself. Crowdsourcing this data without additional technical resources (e.g., a team of individuals) to assist with integration is onerous and impractical. In addition, the inclusion of so-called moving data may present further challenges as the data point moves from one zone to another.

Prior attempts may have involved identifying and/or determining relationships using a database primary key and/or foreign key, as well as through API (or application programming interface) integration. The prior art may display or represent data on floorplans but the data is integrated in the database level using primary keys and without spatial information to resolve relationships. See, for example, Integrate Indoor Mapping Data Format offered by Safe Software and Floor Plan Mapper offered by LaudonTech Solutions Inc.

Attempting to create the foregoing relationships at a database level can result in an extremely complex database design where the relationships and the associated area must be pre-coded and set as a pre-existing requirement. When the concept of partial relationships and the implication of such partial relationships are considered, the database design becomes even more difficult.

As a result, there may be a need for, or it may be desirable to provide a system, method and computer readable medium for braking a shopping cart and/or cooperating environment that overcomes one or more of the limitations associated with the prior art.

### SUMMARY

The present disclosure provides a system, method and/or computer readable medium for data integration.

According to an aspect of one preferred embodiment of the invention, measured or unmeasured maps, floorplans or images (collectively “images”) are designated as a base for a data or process relationship/integration. The base may be used for integration and/or to implement workflows.

According to an aspect of one preferred embodiment of the invention, the use of the present approach may negate the requirement of a user/developer to pre-define a relationship. The integration and relationship may preferably take shape (or be generated) as a data layer is designed using the visual layered approach on top of each other on a measured or unmeasured space, floorplan or image.

According to an aspect of one preferred embodiment of the invention, the present invention is preferably adapted to accommodate changes in a floorplan design, equipment or sensor change and/or changes to the equipment or sensor service.

According to an aspect of one preferred embodiment of the invention, the present invention is preferably adapted to accommodate moving entities (including, but not limited to, a person or a moving zone) in relation to the floorplan. In particular, dynamic integration/relationships may be created between the data points.

According to an aspect of one preferred embodiment of the invention, the present invention facilitates the concept of the zoning of data layers on a measured space for use in a user facing application providing an interface for users (including those with basic computer skills) to layer on desired data in relation to the measured space. The relationship between the desired data layer and the measured space may be used to calculate the relationship with other data zones, including the impact (if any) on business processes or other data sets without requiring a database engineer. Existing data systems may also be used to further extend the relationship between the desired data layer and the measured space. For example, a work order system designed internally may produce an impact based on sensor data being received from multiple different sensors within the measured space. Programming each relationship and impact can be a time consuming and costly process. Inspection of environmental health and safety may also have an impact on compliance regarding the work order that is being dispatched to a person who is going to a space that may have hazardous material. Making these dynamic is crucial to the success of a cost-effective implementation that goes across multiple measured spaces and/or across multiple data layers.

According to the invention, there is disclosed a system for data integration across data sets associated with a reference image from one or more stakeholders. The system includes one or more processors operative to: (i) electronically receive one or more data sets associated with the reference image; (ii) generate one or more data layers for each of the one or more data sets; (iii) combine and/or reconcile the one or more data layers associated with the reference image to generate relationship data; and (iv) compare the reference data with one or more predetermined targets to determine an action associated with the reference image. One or more databases electronically store the one or more data sets, the one or more data layers, the relationship data and the action. Thus, according to the invention, the system is operative to facilitate the determination of relationships between the data sets from the one or more stakeholders.

According to the invention, there is disclosed a method for data integration across data sets associated with a reference image from one or more stakeholders. The method includes: a step of operating one or more processors to electronically receive one or more data sets associated with the reference image to. A step of generating one or more data layers for each of the one or more data sets. A step of combining and/or reconciling the one or more data layers associated with the reference image to generate relationship data. A step of comparing the relationship data with one or more predetermined targets to determine an action associated with the reference image. A step of electronically storing the one or more data layers, the relationship data and the action in one or more databases. Thus, the method uses the relationship data and the reconciled data layers thereof to determine the relationships between the data sets from the one or more stakeholders.

According to the invention, there is disclosed a non-transient computer readable medium on which is physically stored executable instructions for use in association with data integration across data sets associated with a reference image from one or more stakeholders. The executable instructions are such as to, upon execution: (a) collect and/or electronically communicate one or more data sets associated with the reference image to the one or more processors; (b) generate one or more data layers for each of the one or more data sets; (c) combine and/or reconcile the one or more data layers associated with the reference image to generate relationship data; (d) compare the relationship data with one or more predetermined targets to determine an action associated with the reference image; and € electronically store the relationship data, the one or more data layers and the actions in one or more databases. Thus, the relationship data and the reconciled data layers thereof are for use in determining the relationships between the data sets from the one or more stakeholders.

Other advantages, features and characteristics of the present invention, as well as methods of operation and functions of the related elements of the system, method and/or computer readable medium for optimizing cart usage and tracking, and the combination of steps, parts and economies of manufacture, will become more apparent upon consideration of the following detailed description and the appended claims with reference to the accompanying drawings, the latter of which are briefly described herein below.

### BRIEF DESCRIPTION OF THE DRAWINGS

The novel features which are believed to be characteristic of the system, method and/or computer readable medium according to the present invention, as to their structure, organization, use, and method of operation, together with further objectives and advantages thereof, may be better understood from the following drawings in which presently preferred embodiments of the invention may now be illustrated by way of example. It is expressly understood, however, that the drawings are for the purpose of illustration and description only and are not intended as a definition of the limits of the invention. In the accompanying drawings:

FIG. 1 is a schematic diagram of a system for identifying relationships between data layers in accordance with a preferred embodiment;

FIG. 2 is a schematic diagram of a system for depicting relationships between data layers in accordance with a preferred embodiment;

FIG. 3 is a schematic diagram of data layers generated using the zone algorithm in accordance with a preferred embodiment;

FIG. 4A is a schematic diagram of an occupancy data layer in accordance with a preferred embodiment;

FIG. 4B is a schematic diagram of the occupancy data layer shown in FIG. 4A with a lighting data layer in accordance with a preferred embodiment;

FIG. 4C is a schematic diagram of the occupancy data layer and lighting data layer shown in FIG. 4B with a heating layer in accordance with a preferred embodiment;

FIG. 4D is a schematic diagram of the occupancy data layer, lighting data layer and heating data layer shown in FIG. 4C with a hazardous material layer in accordance with a preferred embodiment;

FIG. 5 is a schematic diagram of a system in accordance with a preferred embodiment;

FIG. 6 is a schematic diagram of architecture for the system in accordance with a preferred embodiment;

FIG. 7A is a schematic diagram of staggered return planning using the system in accordance with a preferred embodiment;

FIG. 7B is a schematic diagram of occupancy monitoring, alerts and workflow using the system in accordance with a preferred embodiment;

FIG. 7C is a schematic diagram of workplace cleanliness using the system in accordance with a preferred embodiment;

FIG. 8A is a schematic diagram of classroom occupancy, body data, performance, cleaning, and location data in accordance with a preferred embodiment;

FIG. 8B is a schematic diagram of a floorplan occupancy in accordance with a preferred embodiment;

FIG. 8C is a schematic diagram of elevator occupancy in accordance with a preferred embodiment;

FIG. 8D is a schematic diagram of floorplan noise levels in accordance with a preferred embodiment;

FIG. 8E is an occupancy report in accordance with a preferred embodiment; and

FIG. 9 is a method of operating the system shown in FIG. 5 in accordance with a preferred embodiment.

### DETAILED DESCRIPTION OF THE PREFERRED EMBODIMENTS

Certain novel features which are believed to be characteristic of a relational database system are novel in conjunction with the cooperating environment, according to the present invention, as to their organization, use, and/or method of operation, together with further objectives and/or advantages thereof, may be better understood from the accompanying disclosure in which presently preferred embodiments of the invention are disclosed by way of example. These examples are provided for the purposes of explanation, and not of limitation, of those principles and of the invention. It may be apparent to one skilled in the relevant art(s) how to implement the present disclosure in alternative embodiments.

In the description, like parts are marked throughout the specification and the drawings with the same respective reference numerals. The figures may not be to scale, and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

In accordance with a preferred embodiment, data layers are preferably constructed such that a relationship may be generated between any one or more layers relative to a space (measured or unmeasured) or an image or illustration that has been agreed upon by various stakeholders (i.e., one or more stakeholders) or parties whereby each stakeholder references one predetermined portion of the image or illustration. Relationships may be resolved between the any one or more layers (including between seemingly unrelated data layers and/or between portions of the image that overlap). As a visual approach, the data layers can be used by end users to define a relationship between different sets of information. In addition, highly accurate zoned data can be crowdsourced or be received from multiple different organizations and immediately (or on-demand) integrated with other sourced data without the need for a developer to manually create a data integration application through ETL (or Extract, Transform, Load), primary and foreign key combination or through key value pair.

In the real estate industry, for example, almost all data generated is related to a building and more specifically to a floor plan or measured space. Data may be grouped and/or categorized into sets of data, each set of data having predetermined related information (e.g., lighting, heating, cooling, etc.). If each set of data is designated or presented as a different visual layer with respect to a given measured space to generate a “data layer”, then each data layer may have a unique relationship in relation to the floorplan and/or other data layers. Equipment, service locations, people, processes, sensors are examples of entities that generate data that is relatable to (or may be associated with) the floorplan. A given piece of equipment (“A” for example) may be installed in one location and service one or more other locations. The zones that the equipment (“A”) serves may have overlap with another piece of equipment (“B”), such as a sensor. A given zone may be shared by multiple individuals (e.g., tenants or occupants). Multiple data layer zones may also have partial relationships, which facilitates the extension of data integration across multiple different systems, data points, and/or business processes. Data layer zones may be layered on top of a floor plan/measured space/unmeasured space to create an integration strategy that can dynamically inform and/or impact business processes and/or automation processes.

In accordance with a preferred embodiment, the visual and distributed data integration application of the present invention can be applied to data centers, human bodies, and/or an image (e.g., those that have been agreed upon by multiple stakeholders, such as a group of companies) to use as a reference for data integration without exposing or centrally managing the integration through the individual stakeholder database (i.e., third parties do not need to access another stakeholder database, providing an additional level of data security). Preferably, a primary/foreign key or key value pair or node and connection methodology is applied in, for example, Graph Database. Persons skilled in the art will appreciate that the same methodology can be applied in two-dimensional or three-dimensional spaces.

Persons skilled in the art will understand that in the relational model of databases, a primary key is a specific choice of a minimal set of attributes (columns) that uniquely specify a tuple (row) in a relation (table). A primary key may be considered “which attributes identify a record” and in simple cases may simply be a single attribute (e.g., a unique id). More formally, a primary key may be a choice of candidate key (a minimal superkey); any other candidate key may be an alternate key. A primary key may include real-world observables (or a natural key); for example, for a database of people (of a given nationality), time and location of birth could be a natural key.

Persons skilled in the art will understand that in the context of relational databases, a foreign key is a set of attributes subject to a certain kind of inclusion dependency constraints, specifically a constraint that the tuples consisting of the foreign key attributes in one relation, R, must also exist in some other (not necessarily distinct) relation, S, and furthermore that those attributes must also be a candidate key in S. A foreign key is a set of attributes that references a candidate key (e.g., a table called TEAM may have an attribute, MEMBER_NAME, which is a foreign key referencing a candidate key, PERSON_NAME, in the PERSON table. Since MEMBER_NAME is a foreign key, any value existing as the name of a member in TEAM must also exist as a person's name in the PERSON table; in other words, every member of a TEAM is also a PERSON.

Persons skilled in the art will understand that a primary key uniquely identifies a record in the relational database table, whereas a foreign key refers to the field in a table which is the primary key of another table. A primary key must be unique and only one primary key is allowed in a table which must be defined, whereas more than one foreign key is allowed in a table. In other words, the primary key is used to identify the records in the table uniquely while the foreign key is used to connect two tables together.

Persons skilled in the art will understand that an attribute-value pair (or name-value pair, key-value pair, or field-value pair) is a fundamental data representation in computing systems and applications. An open-ended data structure is typically desired that allows for future extension without modifying existing code or data. In such situations, all or part of the data model may be expressed as a collection of 2-tuples in the form <attribute name, value> with each element being an attribute-value pair.

Persons skilled in the art will understand that a graph database is a database that uses graph structures for semantic queries with nodes, edges and properties to represent and store data. A key concept of the system is the graph (or edge or relationship). The graph relates the data items in the store to a collection of nodes and edges, the edges representing the relationships between the nodes. The relationships allow data in the store to be linked together directly and, in many cases, retrieved with a single operation. Graph databases hold the relationships between data as a priority. Querying relationships is quick because they are stored in the database. Relationships may be intuitively visualized using graph databases, making them useful for heavily inter-connected data.

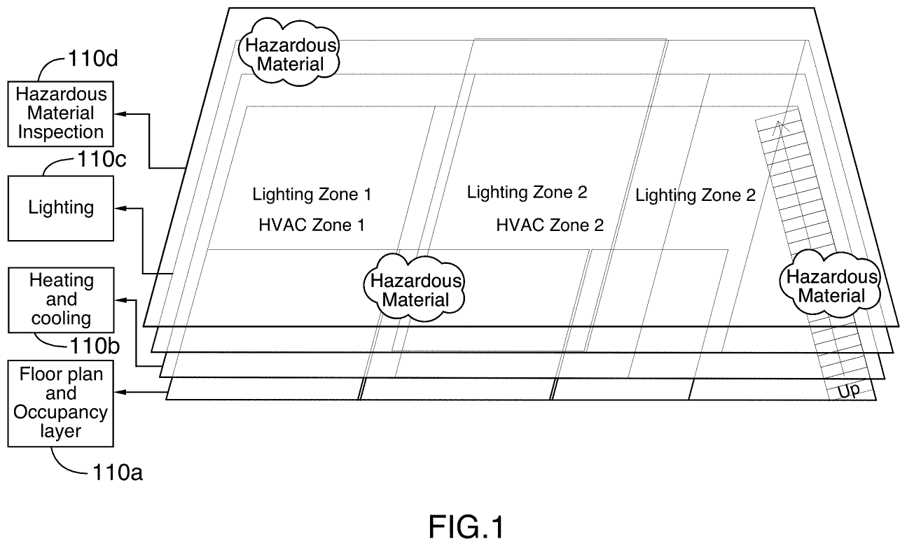

In order that the invention may be more fully understood, it will now be described, by way of example, with reference to the accompanying drawings in which FIG. 1 through FIG. 9 illustrate embodiments of the present invention.

System:

Embodiments of the system described herein may be implemented in hardware or software, or a combination of both. These embodiments may be implemented in computer programs or algorithms executing on programmable computers, each computer including at least one processor, a data storage system (including volatile memory or non-volatile memory or other data storage elements or a combination thereof), and at least one communication interface.

Each program may be implemented in a high-level procedural or object-oriented programming or scripting language, or both. Alternatively, the programs or algorithms may be implemented in assembly or machine language, if desired. The language may be a compiled or interpreted language. Each such computer program may be stored on a non-transitory computer-readable storage medium (e.g., read-only memory, magnetic disk, optical disc). The storage medium so configured causes a computer to operate in a specific and predefined manner to perform the functions described herein.

As the term “block” is used in the description of the various embodiments, a block includes a functional block that is implemented in hardware or software, or both, that performs one or more functions such as the processing of input data to produce output data.

Referring to FIGS. 1 through 9 there is shown a system 100 and the method 1000 and/or under influence of a related computer readable medium 1100.

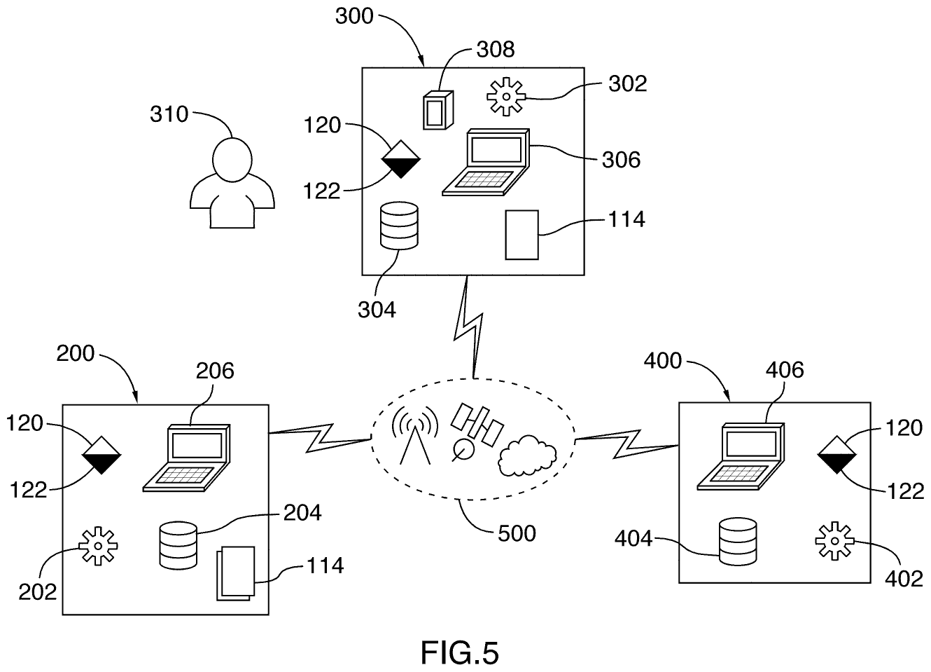

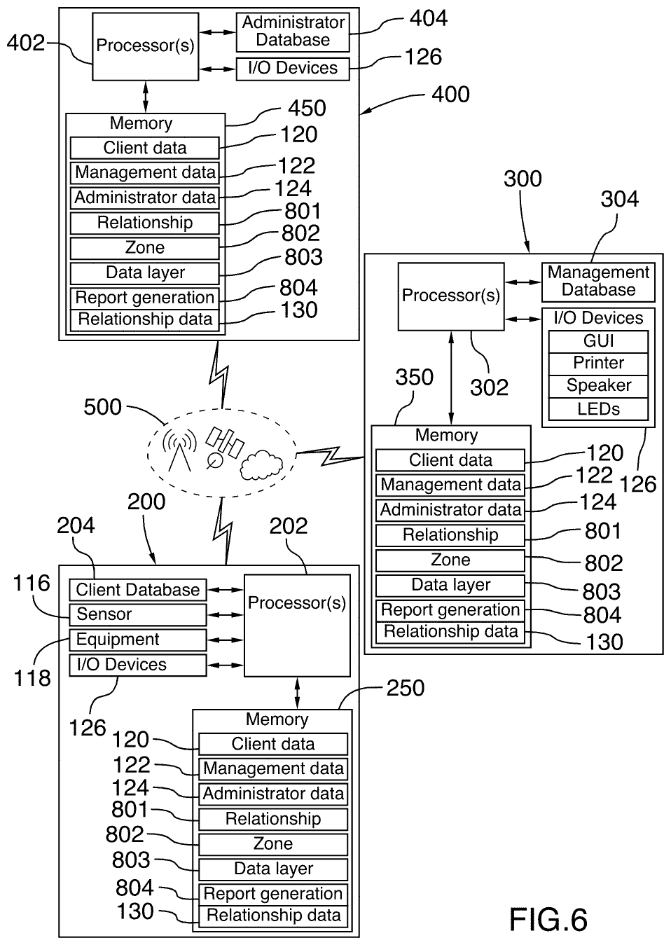

Some parts of the system 100 depicted in FIGS. 5 and 6 may be provided at a remote location. Preferably, and as best seen in FIGS. 5 and 6, the system 100 includes a client subsystem 200, a management subsystem 300, and an administrator subsystem 400.

In accordance with a preferred embodiment of the present invention, a map or floorplan (measured or unmeasured) or image is the basis for the integration strategy. By designating the map or image as the base information, different data points can preferably be layered on top of the base to identify one or more relationships across otherwise separate (or independent) data sets from multiple different sources—internal and external. A traditional database may preferably be used for further integration or data storage.

Client Subsystem:

In accordance with a preferred embodiment, the system 100 includes a client subsystem 200 having a client processor 202, a client database 204, and a client-facing application 206 (e.g., a web-based application) that enables clients (e.g., tenants of residential, urban office and association properties) to communicate with management (e.g., property managers) in order to send queries and/or requests. The queries and/or requests are preferably included as client data 120.

In accordance with a preferred embodiment, FIG. 1 depicts data layers 110 and the organic relationships created between one or more layers 110 (e.g., hazardous material 110d, lighting 110c, heating and cooling 110b). The common basis, or reference, for the integration between the layers 110 is preferably a map (measured or unmeasured) of a desired area—for example, a building floor plan—or an image. The map 110a (alternately “reference map 110a”, “reference layer 110a” or “reference image 110a”) may include dimensions or measurements for a predetermined or desired two-dimensional area or three-dimensional space. The dimensions or measurements may preferably be used to generate coordinates to position objects (e.g., equipment, sensor, occupant, interior walls, etc.) within the space represented by the map 110a. Once the map 110a is generated, additional data layers 110 including the desired information may be built up as shown in FIG. 1. For example, a data layer 110 including suites information may be positioned or layered on top of the reference map 110a. In one embodiment, a data layer algorithm 803 may preferably be applied to allow a user (internal or external with proper permission) to generate additional data layers 110 on top of (or otherwise associated with) the map 110a to generate one or more data zones 112 within the map 110a. For example, as shown in FIG. 1, additional data layers 110 may include a heating and cooling layer 110b, a lighting layer 110c, and a hazardous material inspection layer 110d. Substantially contemporaneously or at a predetermined time, a relationship algorithm 801 may preferably be applied to generate a relationship (association or interface) between one or more data layers 110 without any user knowing or having access to other data layers 110 generated by third parties or alternate (internal or external) data sources. For example, the relationship algorithm 801 may be applied to generate relationship data 130 that includes a determine of the relationship between the hazardous material inspection layer 110d and the heating and cooling layer 110b to identify any heating, ventilation and/or air conditioning components located in close proximity to the location of any hazardous materials.

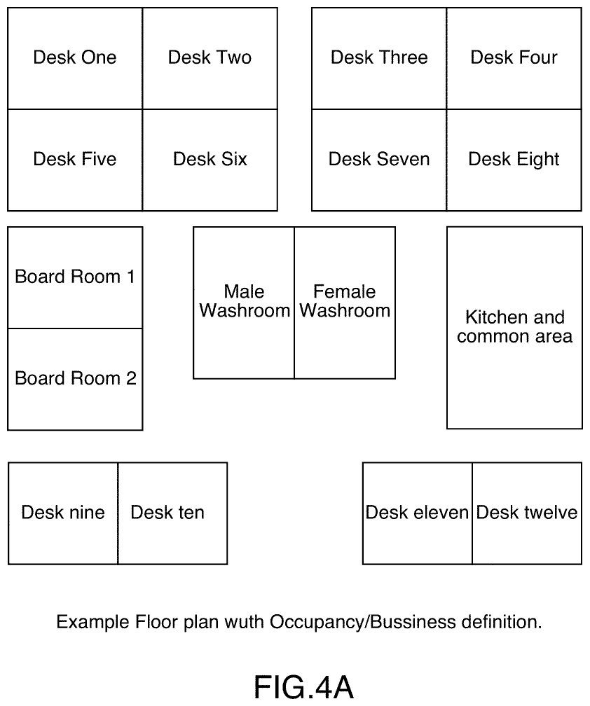

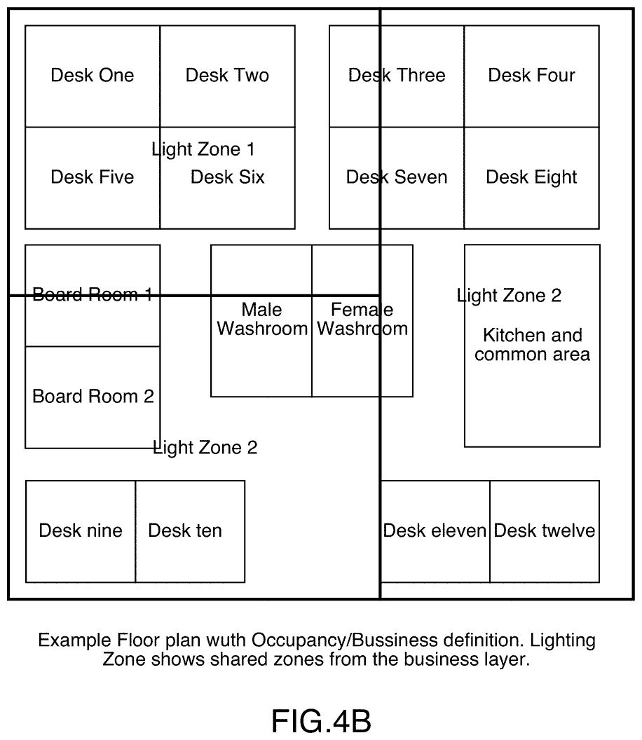

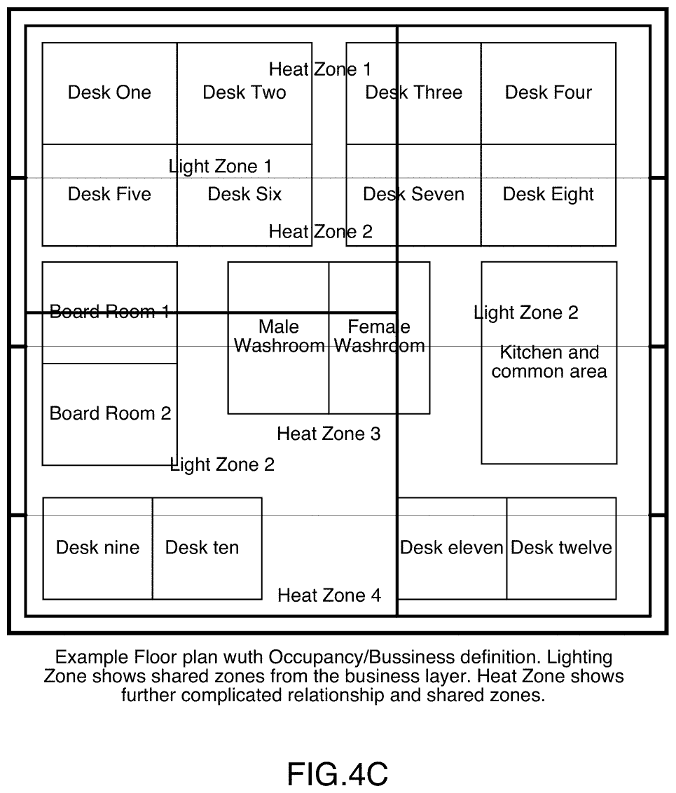

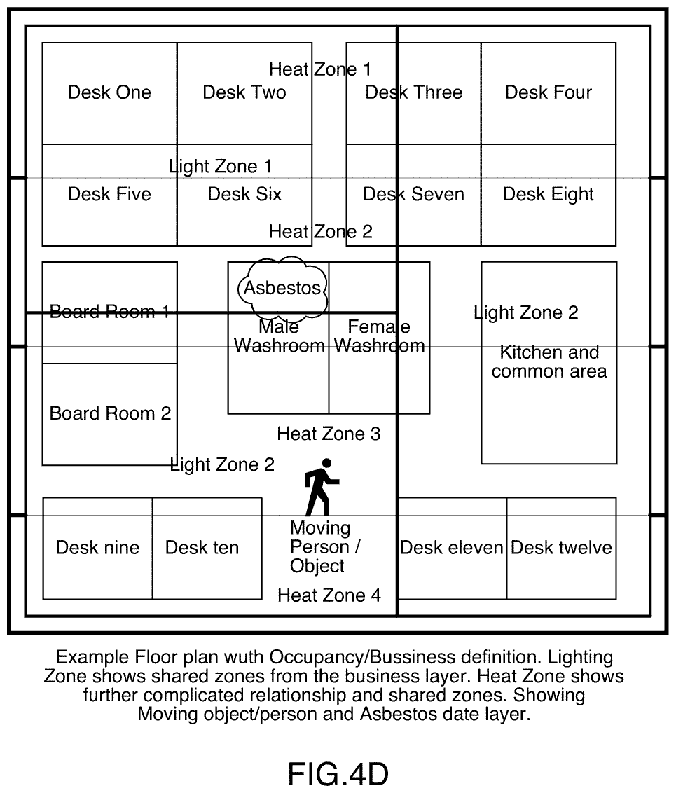

In a preferred embodiment, one exemplary data layer 110 includes suite information, as shown in FIG. 4A. The suite information may preferably include, for example, the position of each individual suite on the map 110a. One or more occupant(s) may be created along with a functional description layer for each suite. Each suite may be assigned a particular use or purpose—for example, desk, cubical, office, kitchen, boardroom, break out room, washroom, etc. This functional description layer 110 may also include the occupant information—for example, the identity of the occupant(s) within each suite, how many occupants can share a suite, board room capacity, etc. This meta information about the space represented by the map 110a is adapted to generate relationship data 130 which includes the identification of relationships between data layers 110 and facilitates decision making processes by users and/or by processors (e.g., for automated functions such as heating and cooling, lighting, etc.). For example, the system 100 of the present invention may be adapted to alter lighting and/or heating/cooling in a desired zone 112 (e.g., a specific suite, or group of suites, depending on occupant preferences, energy efficiency determinants, etc.). For example, the system 100 of the present invention may be adapted to notify occupants of a specific suite, or group of suites, to vacate the suite due to the identification of hazardous material(s) in the area. The system 100 of the present invention may also be adapted by management for use to determine, for example, the amount of waste produced by a given occupant and/or the amount of services consumed by a given occupant.

In a preferred embodiment the system 100 may be adapted to additionally accommodate and/or track moving objects and/or occupants within the map 110a and/or space and the changing relationship of the objects and/or occupants with the different data layers 110 (and different business conditions) based on relative location within the map 110a and/or space. In accordance with a preferred embodiment, the moving object and/or occupant is represented as a data layer 110e on top of the map 110a, as shown in FIG. 4D. As the object/occupant moves from one zone to another in relation to the floorplan, the relationship (using the relationship algorithm 801) between the object/occupant and the one or more data layers 110 is automatically updated as relationship data 130 and may result in one or more actions or business cases based on, for example, the comparison of the relationship data 130 to a predetermined reference target or value. For example, if the occupant leaves a designated suite for more than a predetermined amount of time, the heating ventilation and air conditioning apparatus for the suite may turn off to conserve electricity.

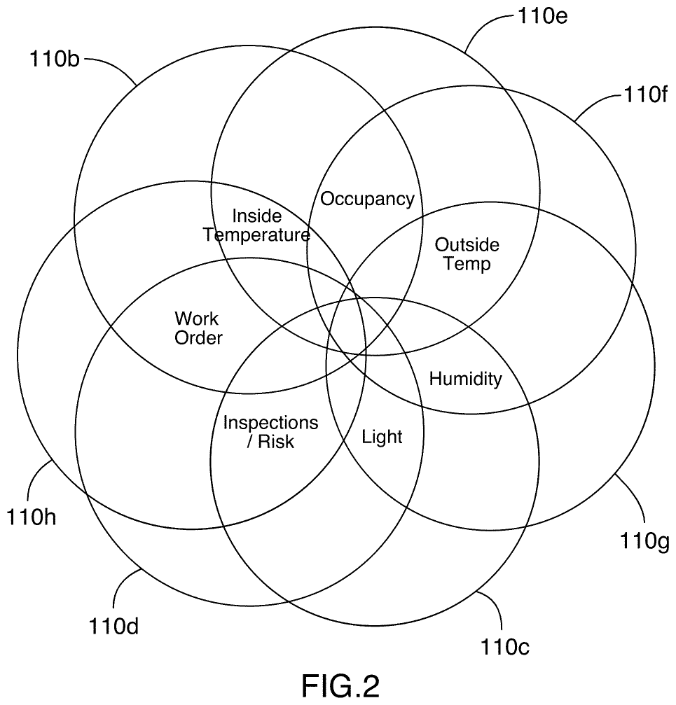

In accordance with a preferred embodiment, FIG. 2 depicts an alternate representation (i.e., shown without the map 110a) of multiple overlapping data layers 110 including, for example, occupancy 110e, outside temperature 110f, humidity 110g, light 110d, inspections/risk 110d, work orders 110h, and/or inside temperature 110b. The data layers 110 may have different overlapping relationships with one or many other data layers 110. The degree of overlap between each data layer 110 may have different implications. These different implications may be difficult to implement using traditional databases of the prior art. For example, for a group of occupants that have various preferences for temperature 110b (i.e., warmer or cooler) and lighting levels 110c (i.e., brighter or dimmer) sharing an office space, the associated data layers for occupancy 110e, light 110c and inside temperature 110b will have particular degrees of overlap based on the preferences (e.g., individual preference for desk location, preference for proximity to others seated around the individual and his/her neighbours will need to be identified to deploy automation using a variable air volume controller, lighting controller, blind or shade controller). For example, for a work-order 110h being dispatched for a person to attend an area that may have hazardous materials (e.g., based on data provided in the inspection layer 110d) and a preventive maintenance informing a corrective maintenance that has impact on an occupant zone (e.g., as determined by the occupancy layer 110e) and comfort that needs to be communicated, the representative data layers will have particular degrees of overlap based on the degree of hazard and/or corrective maintenance required. The spatial information (e.g., coordinates) from the measured space/floor plan is the basis for the relationship as it is shown in FIG. 1—where one data layer 110 intersects with another data layer 110 and how their relative positioning on top of the floorplan 110a creates an integration/relational structure of data from one data source to another (e.g., If hazardous materials data exists for a space where the occupant is identified and preventive/corrective maintenance is created for the same space, then the person coming to perform the corrective maintenance may need to know about the hazardous materials data information. The ability to create a standard operating procedure where any corrective maintenance information should try to identify any hazardous material related information and dispatch that to the occupier or maintenance provider could be automated).

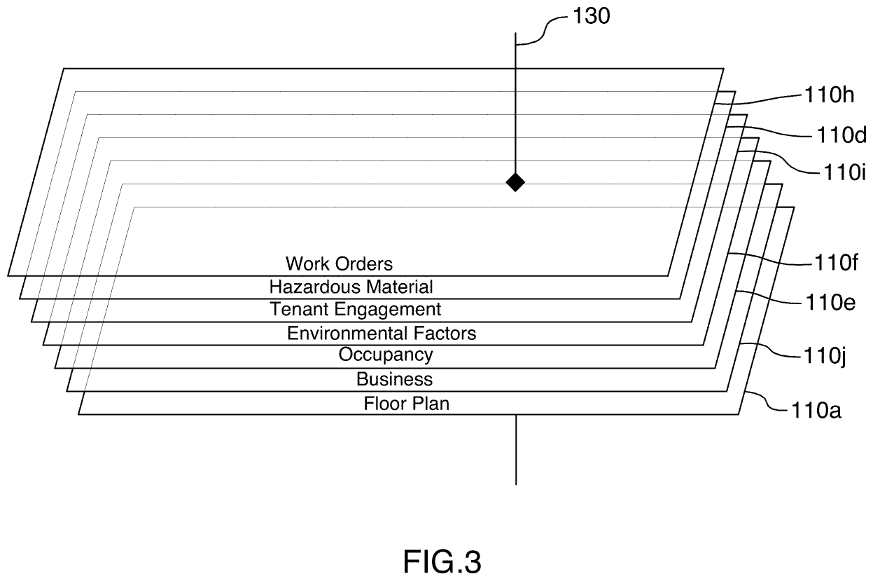

As shown in FIGS. 3 and 4A-D, in a preferred embodiment, data zones 112 are generated using a zone design tool 802 or zone algorithm 802. Using the tool 802, a user can define or create a map 110a (or image 110a) and designate it as the base layer 110a (or “reference layer 110a”). Subsequent to generating the base layer 110a, additional data layers 110 can be “layered” on (or associated with) the base layer 110a. For example, the tool 802 may be used to generate a business layer 110j and an occupancy layer 110e to define the location of different business units, the functionality of each defined unit (e.g., suite, workstation, office, kitchen, telecom room, boardroom, etc.) as well as the occupants of the different business units. Additional data layers 110 can be added on top of (or associated with) the business layer 110j and an occupancy layer 110e by a user (e.g., an internal or external third party) and the user can define where and/or how their data relates to the floorplan 110a (e.g., environmental factors 110b, tenant engagement 110i, hazardous material 110d, work orders 110h). For example, reports 114 may be associated with one or more data layers 110 including, for example, a tenant certificate of insurance can be associated with the entire tenant space; an asbestos report may be associated with an entire floor, multiple floors or a specific location within the building. In addition, one or more sensors 116 may be associated with a small workstation to identify occupancy; and another sensor 116 can be calibrated to identify vibration for the entire floor. Because all of these data layers 110 are being designed (or layered) on top of the map 110a, the positioning of the object or variable on (or within) the map 110a can be used as the common relatable “Key” to generate relationships between the data layers 110. As this space information is common across multiple data layers 110 and data zones 112, this information can preferably be used to automatically generate a relationship between data generated by a plurality of different sources without needing a technical team to design and implement a data integration strategy for each individual data source. Persons skilled in the art will appreciate that additional data layers may be generated by the client, management and/or the administrator using the data layer algorithm 803.

In accordance with a preferred embodiment, layering the measured space 110a and data zones 112 on top of one another (e.g., in a predetermined alignment) may preferably inform the data relationship including the precise location of the relationship between two different data layers 110. From the previous example, if asbestos is in a specific location (e.g., as shown in FIG. 4D) in a floor and a work order 110h is created where the asbestos does not exist, the building owner does not need to notify the person about a safety precaution. However, if the individual is going to a location that has asbestos and may get exposed to that then the building owner/operator is obligated to notify the individual. Partial zone and moving object/occupant relationships (e.g., as shown in FIG. 4D) can preferably be leveraged with respect to the measured space to automate business processes in accordance with a preferred embodiment of the present invention.

In accordance with a preferred embodiment, the client subsystem 200 includes one or more sensors 116 and equipment 118 associated with the map 110a (or image 110a). The sensors 116 may include sensors adapted for monitoring movement, temperature, lighting levels, humidity, leak detection, environment (e.g., ammonia, UV, noise, lumen value, vibration, etc.), camera, parking, heart rate, breathing rate, cement/concrete curing, etc. The equipment 118 may include equipment adapted for temperature control (e.g., a furnace or air conditioning unit), lighting, blind or shade controller, actuators, access control, parking mechanics, man trap, robotic vacuum cleaner, drone, etc. The sensors 116 and equipment 118 are adapted to generate data associated with each data layer 110 that is preferably included (or captured) within each corresponding data layer 110a, 110b, 110c, 110d, 110e, 110f, 110g, 110h, 110i, 110j, 110k, 110m and/or data zone 112.

In accordance with a preferred embodiment, client data 120 includes data received from sensors 116, data received from equipment 118, data generated by data zones 112 and data corresponding to the different data layers 110a, 110b, 110c, 110d, 110e, 110f, 110g, 110h, 110i, 110j, 110k, 110m (collectively “data devices”).

In accordance with a preferred embodiment, applications of the present invention may include but are not limited to: (1) data visualization and analytics across multiple data layers 110; (2) heating and cooling requests from individual occupants that are sharing a room zone; (3) compliance with a hazardous material notification; (4) utility billing where a meter is being shared by multiple tenants; (5) relationship of data from different sources and implementation of business cases based on the data; and/or (6) crowd source data without exposing an internal data infrastructure (e.g., A company may have their own data structure and their own system and data environment. The company sends data to a system that is accessible by a client or another partner. The client and/or partner can do the same. Both parties can agree upon a visual data integration strategy—zone in a measured or unmeasured floor plan or space or a zone in a simple image or illustration to facilitate data integration without requiring exposure of internal/proprietary data structures or having a third party developer manually create the relationship).

In a preferred embodiment, the system 100 includes more than one client subsystem 200 to facilitate the generation of relationships between more than one client.

Management Subsystem:

In accordance with a preferred embodiment, the system 100 includes a management subsystem 300 having a management processor 302, a management database 304, and a management-facing application 306 (e.g., a web-based property management application) that enables managers (e.g., landlords of residential, urban office and association properties) to communicate with clients (e.g., respond, via management data 122, to queries and/or requests provided as client data 120) and/or take complete control of every aspect of their business (e.g., including the rent, vacancy, maintenance cycles and/or assets). In a preferred embodiment, the system 100 may be adapted in a real estate context to streamline management of the rent cycle including providing features such as, for example, tenant and lease tracking, full general ledger accounting, automated rent and late fee reminders and on-demand reports. Additionally, the system 100 may be adapted to provide automated rent collection; and property managers can receive online payments via the client-facing application 206. In accordance with a preferred embodiment, the system 100 may also facilitate management of the vacancy cycle by broadcasting vacancies to listing partners and/or an administrator platform 406. The administrator platform 406 preferably provides a customizable online rental application form and the information provided by an applicant is stored in the administrator database 404 as administrator data 124. The administrator platform 406 preferably provides a client screening service (e.g., running background checks). Clients and management can both submit requests.

The management subsystem 300 additionally includes a mobile application 308 to facilitate communication with facility teams 310 for performing day-to-day activities efficiently and on time (e.g., receive work order management, inspections, incident tracking and preventive maintenance). The mobile application 308 preferably optimizes the ability of management to respond to (e.g., management data 122), for example, client requests (e.g., client data 120), improve technician productivity, supervisor visibility and risk management, including: receiving and performing work orders; scheduling, tracking and dispatching equipment maintenance and/or repairs; creating, assigning and deploying routine inspections; capturing and managing critical incident information on location; dispatching a technician; initiating work orders from sensors, enterprise resource planning, client relationship management and/or other sources; attaching photos, files and/or audio to any record; working offline and synchronizing to a processor 202, 302, 402 when the device receives a network connection; and/or direct connectivity to the enterprise resource planning.

In a preferred embodiment, the system 100 includes more than one management subsystem 300 to facilitate the generation of relationship between more than one manager.

Administrator Subsystem:

In accordance with a preferred embodiment, the system 100 includes an administrator subsystem 400 having an administrator processor 402, an administrator database 404, and an administrator platform 406 (e.g., a web-based application). As shown in FIGS. 5 and 6, the administrator subsystem 400 is in communication with the client subsystem 200 and the management subsystem 300 via a communication network 500.

In FIGS. 5 and 6, the system 100 is shown in use with the communication network 500. The communication network 500 may include satellite networks (e.g., GPS), terrestrial wireless networks, and the Internet. The communication of data between the subsystems 200, 300, 400 may also be achieved via one or more wired means of transmission or other physical means (e.g., a Universal Serial Bus cable and/or flash drive) of transmission. Persons having ordinary skill in the art will appreciate that the system 100 includes hardware and software.

### EXAMPLES

(1) Occupancy Monitoring:

In accordance with a preferred embodiment, the system 100 is adapted to optimize workspaces and/or staffing of the workspaces based on actual usage and dwell time information. Using an occupancy sensor in combination with camera data and real-time locating system (RTLS; using RTLS tags associated with people and/or objects) data, relationships can be identified and created between an occupant and one or more data zones. For example, a person may be associated with a data zone but because the person has a meeting, they could be at a different location at a given moment. Dynamically updating the location of the person and the ability to set a preference based on that occupancy change within a given zone provides highly personalized levels of experience. It is not possible to scale if database level relationships must be made for each data point.

(2) Leasing Data:

In accordance with a preferred embodiment, the system 100 is adapted to combine leasing and occupancy data to optimize space utilization and increase lease rates. Determining occupancy levels for a suite, or sub-lease, elevator usage, access control usage could inform s landlord if a tenant is ready to expand or may need to scale down. If it appears that a tenant needs expansion, a member of the landlord's leasing team can reach out to the tenant before they seek out a different space with competition. If it appears that a tenant needs to down-size, a member of the landlord's leasing team can reach out to the tenant to discuss terms for potentially down-sizing.

(3) Vendor Risk:

In accordance with a preferred embodiment, the system 100 is adapted to digitize and/or automate vendor compliance tracking to ensure all vendor risks are identified and addressed. When a vendor is coming to a space to work—identifying the vendor's service type and the building risk compliance requirement for that service type will need to be identified and checked dynamically.

(4) Energy & Sustainability:

In accordance with a preferred embodiment, the system 100 is adapted to use occupancy data to control HVAC and lighting for energy efficiency. Using an occupancy sensor or an entry/exit sensor or camera data identifies occupancy level, body temperature(s), zone size, current temperature and variable air volume controller that controls the temperature of that zone to increase or decrease the temperature depending on the foregoing factors.

(5) OT & Smart Building:

In accordance with a preferred embodiment, the system 100 is adapted to use this single pane of glass portal for all Internet-of-Things (IoT) and proptech solutions. Occupancy, entry/exit, leak detection, indoor environmental sensors, temperature, light, access control, etc. generate data that can be layered through the system and method of the present invention.

(6) Leak Detection:

In accordance with a preferred embodiment, the system 100 is adapted to alert building operators, dispatch vendors for repair and restoration, and keep tenants up-to-date with multi-channel notifications. When a leak is detected, the tenant and the occupant of that space, their contact information and communication protocol need to be identified. In addition, the SOP for the building in which the zone is located also needs to be identified. The building operation, escalation policy, vendor providing remediation and restoration services should also be identified. Since the foregoing information may be provided by different sources, the system of the present invention facilitates the creation of a dynamic relationship between the silos and provides automation capability according to the SOP.

(7) Accounting:

In accordance with a preferred embodiment, the system 100 is adapted to monitor tenant industry exposure and outstanding accounts receivable balances. As above, determining the occupancy level for a suite, or sub-lease, elevator usage, access control usage may inform the landlord if a tenant is ready to expand or needs to scale down. If it is determined that the tenant needs expansion, a member of the landlord's leasing team can reach out to the tenant before they seek out a different space with competition. If it is determined that the tenant needs to down-size, a member of the landlord's leasing team can reach out to the tenant to facilitate the down-sizing.

(8) Tenant Risk:

In accordance with a preferred embodiment, the system 100 is adapted to digitize and automate tracking of tenant certificates of insurance to ensure all tenants have correct and valid coverage. A building and a suite within the building may have different certification of insurance requirements for their commercial tenant based on the risk exposure of the building and their hazardous material status. Associating this with the insurance requirement and tracking that insurance compliance can be onerous if it is not done using a distributed data integration strategy.

(9) Client Experiences:

In accordance with a preferred embodiment, the system 100 is adapted to offer multi-channel client engagement, including a chatbot to automate the client experience. In the real estate context, a tenant client may have hundreds of occupants in a given space and their communication protocols may differ. The reference layer 110a may be a measured space or an illustration of the office setup. With respect to communication protocols, some occupants may request SMS, some may prefer email, some may request a phone call. In a traditional model, the tenant would need to provide the data structure, API and expose their occupant contact information to the landlord. But in a distributed integration model, landlord data and tenant data do not need to be transferred between siloes and can still work from their own respective locations based on the workflow and zone relationship.

(10) Operations:

In accordance with a preferred embodiment, the system 100 is adapted to digitize, manage and enter into an accounting system, all work orders.

(11) Return to Work with Social Distancing:

In accordance with a preferred embodiment, the system 100 is adapted to facilitate real-time anonymous data management and provide the flexibility (e.g., planning, monitoring, alerting and acting on multiple fronts) to ensure employees can return to a workplace safely.

(a) Staggered Return Planning

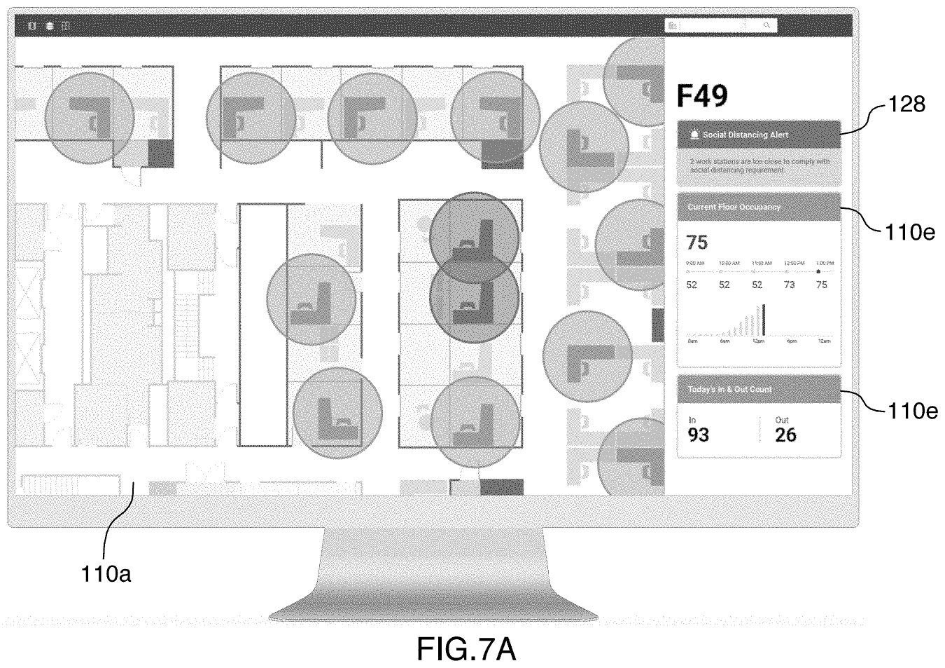

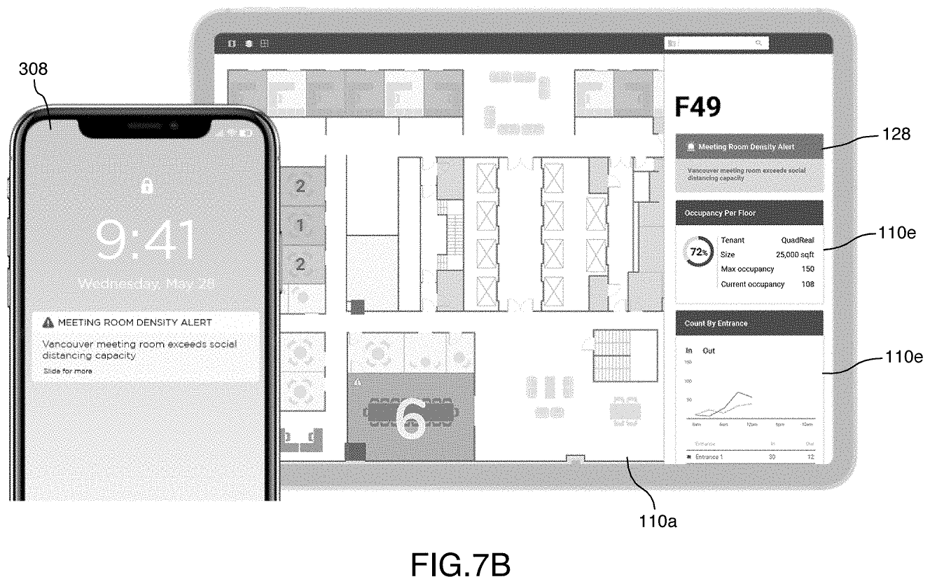

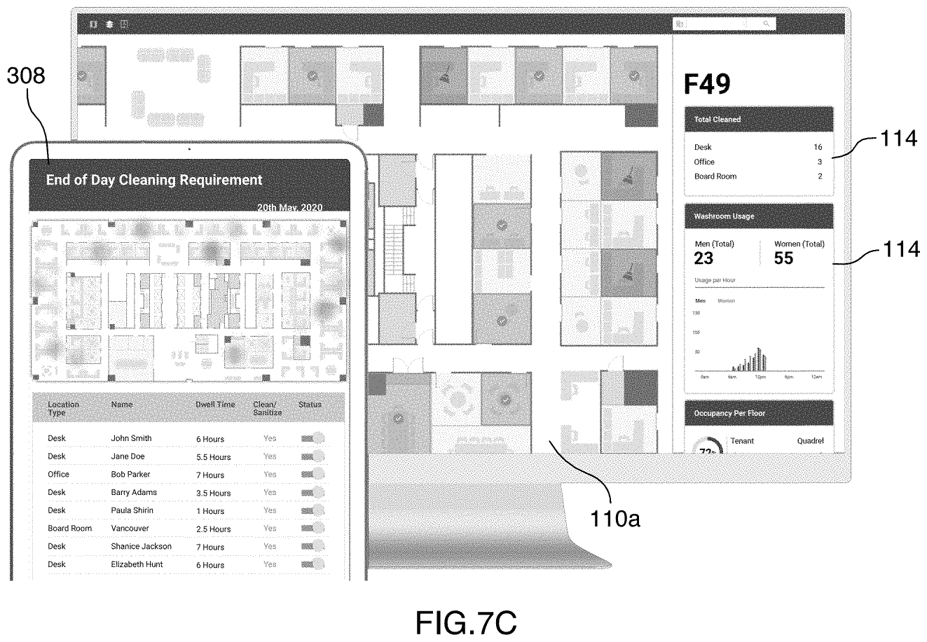

As depicted in FIG. 7A, managers and/or tenants, using the management facing application 306 and/or the client facing application 206 respectively, can effectively plan in compliance with social distancing standards, including for example: staggered work groups; distanced workstation assignments; alternating work group schedules; setting maximum capacities for assigned workstations and use access control, desk occupancy sensor and also create cleaning requirement report for advance cleaning based on usage.

In accordance with a preferred embodiment, FIG. 7A depicts a social distancing application of the present invention. A map 110a is shown. The occupancy data layer 110e indicates the number of occupants in the floorplan (the current floor occupancy, including the occupancy levels over time) and the daily entry and exit count. The location data layer may also be included to provide the location of the occupant(s) and, for example, to provide an alert 128 (e.g., work stations are too close to comply with social distancing requirement) if the distance between workstations is less than a predetermined threshold distance. A relationship between each of the one or more data layers (e.g., occupancy and location of occupants) can be determined using the relationship algorithm.

(b) Occupancy Monitoring, Alerts & Workflow

As depicted in FIG. 7B, using the management facing application 306, managers are able to, for example: monitor occupancy density and dwell times of common spaces such as meeting rooms, washrooms, and lobbies; receive alerts when occupants are not social distancing at entry and exit points, or are tailgating through controlled doorways; automate workflows according to company policy to ensure employee safety and standard operating procedures.

In accordance with a preferred embodiment, FIG. 7B depicts a social distancing application of the present invention. A map 110a is shown. The occupancy data layer 110e indicates the number of occupants in the floorplan (the maximum occupancy, size of the floor, and current occupancy). The number of occupants entering and exiting the floor is also determined. The location data layer may also be included to provide the location of the occupant(s) and, for example, to provide an alert 128 (e.g., meeting room density alert) if the number of occupants in a predetermined proximity exceed a threshold. A relationship between each of the one or more data layers (e.g., occupancy and location of occupants) can be determined using the relationship algorithm.

(c) Workplace Cleanliness

Indoor environment quality monitoring and optimization of cleaning and sanitation are depicted in FIG. 7C. In accordance with a preferred embodiment, FIG. 7C depicts a floorplan cleaning application of the present invention. A map 110a is shown. The work order 110h (e.g., cleaning information) indicates the offices, desks, and boardrooms to be cleaned (including the cleaning status). In addition, the mobile application 308 depicts the map 110a and end of day cleaning requirement for a given date. The location type (i.e., desk, office, boardroom), name, dwell time of the occupant, type of cleaning required and the cleaning status are all depicted. A relationship between each of the one or more data layers (e.g., occupancy dwell time and type of cleaning required) can be determined using the relationship algorithm.

The system 100 may be adapted to monitor indoor environment quality using the management facing application 306 and/or the client facing application 206. For example, as COVID-19 is a respiratory infection, indoor environment and air quality are important aspects to consider for the avoidance of disease transmission. In a preferred embodiment, the system 100 monitors different data points including (but not limited to) temperature, humidity, CO₂ density, CO density and ammonia to provide an optimal and safe working environment. The system 100 preferably monitors each of the data points to ensure that they are within predetermined acceptable levels. In addition, the system 100 may be adapted to combine the data points into a comprehensive score to provide a single indicator of the indoor environment quality.

The system 100, may be adapted to optimize cleaning and sanitation using the management facing application 306 and/or the client facing application 206. For example, the system 100 preferably integrates occupancy and traffic data into the management facing application 306 to ensure their work carried out by the facility teams 310 is targeted and thorough. Verification of cleaning and disinfection can be recorded and communicated to tenants for their confidence that a safe work environment is being maintained.

(d) Deployment and Tracking Sensors

The system 100, may be adapted to facilitate digital asset inventory database tracking using the management facing application 306 and/or the client facing application 206. For example, the system 100 may preferably record the respective locations of leak detection sensors and IEQ (indoor environmental quality)/occupancy sensors, records of warranties, service, characteristics, performance, and gauges.

In addition, the system 100 may preferably manage, for example, the visual onboarding of new equipment assets, the deployment of new or existing sensors or equipment on the floor plan, and/or warranties, location, performance, and gauge data.

(e) Client Engagement & Communication

The system 100, may be adapted to facilitate efficient and timely multi-channel communication between a tenant and property management, for example, to keep tenants informed and engaged.

The system 100 (for example, between the management facing application 306 and the client facing application 206) can communicate using multiple outlets, including: existing facility management; customer relation management and enterprise resource planning tools; tenant engagement tools; elevator screens.

In a preferred embodiment, correspondence initiated by the client subsystem 200 is transmitted as client data 120 and correspondence initiated by the management subsystem 300 (e.g., in response to the tenant data 120) is transmitted as management data 122. In a preferable embodiment, the management data 122 may include a work order 110h.

(f) Additional Datasets

In addition to sensor data, the system 100 is adapted to monitor and/or incorporate additional datasets using an incremental approach, for example. The system 100 can preferably be adapted to layer alternative datasets including: expert inspections; Office 365 integration; preventive and corrective work orders.

(g) Integrated Vendor Compliance

Property management has transitioned from mostly insourced work to outsourced work over the past generation. Janitorial, parking and security contractors often wear the management company uniform as an extension of the operations staff. Materials and parts suppliers as well as consultants are also often outsourced by property management for building operations.

The system 100 is preferably adapted to integrate inspection reporting and, for example, COVID-19 related compliance data (e.g., using the management facing application 306 and/or the client facing application 206) to ensure vendors are complying with predetermined operating standards.

The system 100 is preferably adapted to ensure vendors are compliant with, for example: certificates of insurance (COI); Workers Compensation Board (WCB) requirements; trade licences; training certificate; etc.

Vendor management companies in the prior art typically charge vendors significant annual fees. Vendors are often forced to join multiple systems for their various clients. As this is a relatively new cost, vendors often look to charge the annual fees back to their clients (e.g., property management companies). Smaller vendors or companies that perform infrequent or one-off type work, typically cannot justify joining a system.

In accordance with a preferred embodiment, the system 100 provides the ability to have visibility without charging a fee to the vendors. Furthermore, the information and compliance status can be integrated into your purchasing and work order solutions, reducing risk throughout the procurement lifecycle.

Additional Applications:

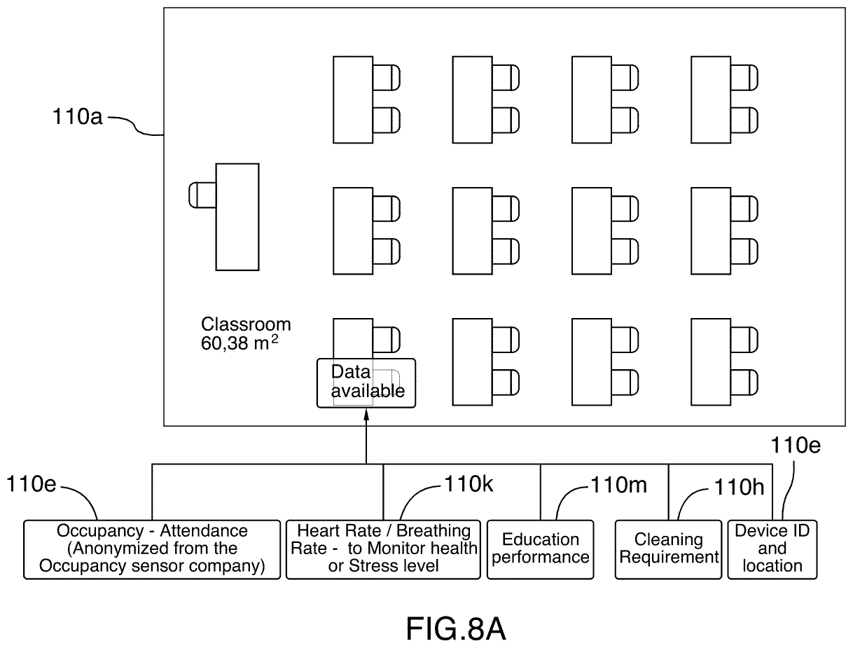

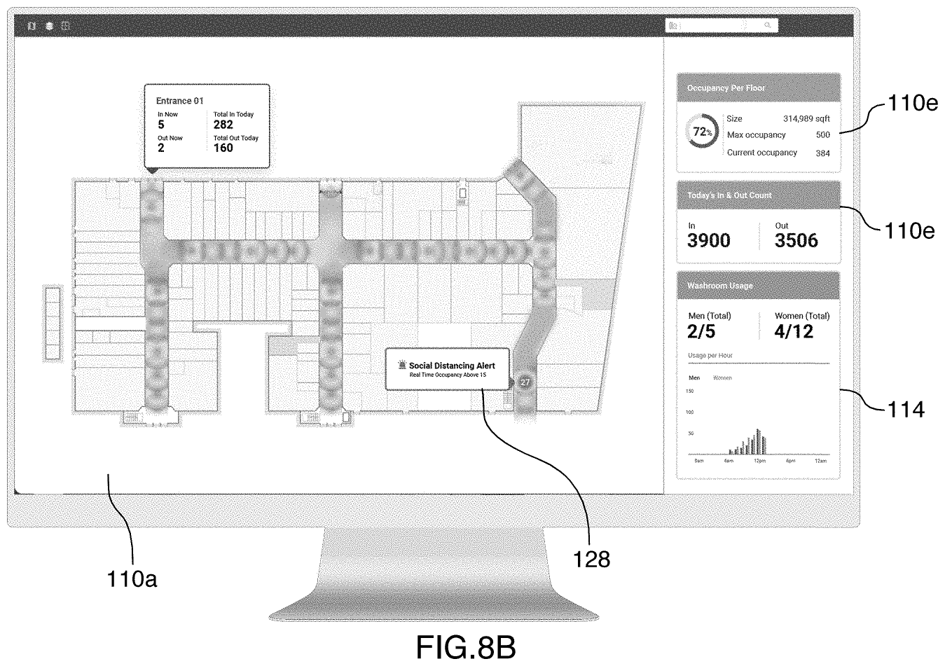

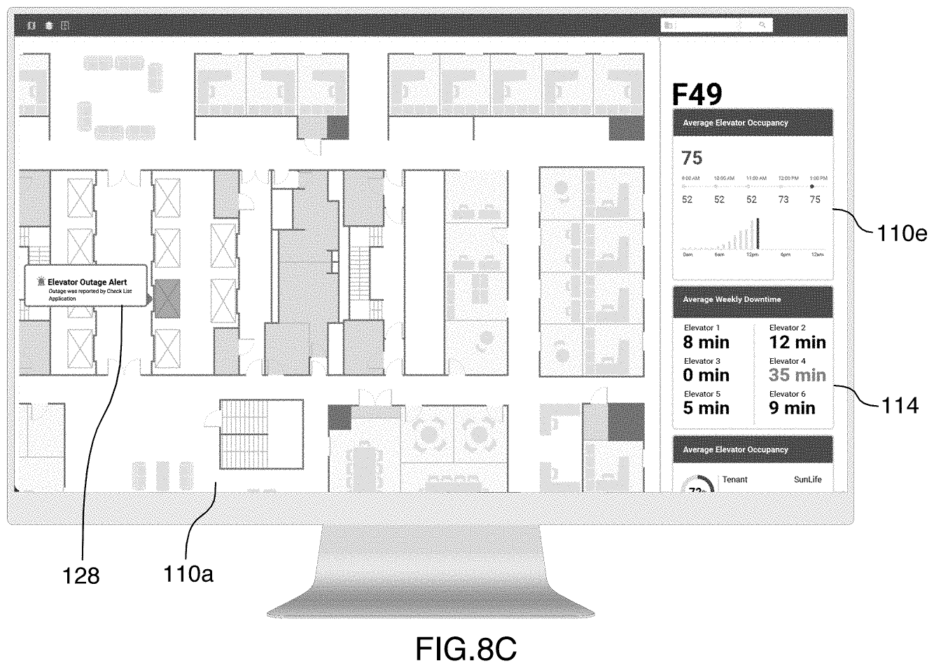

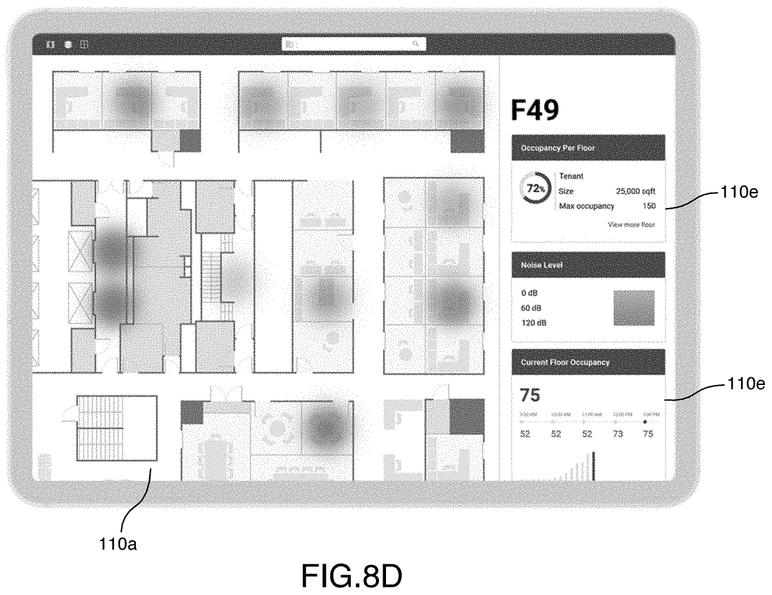

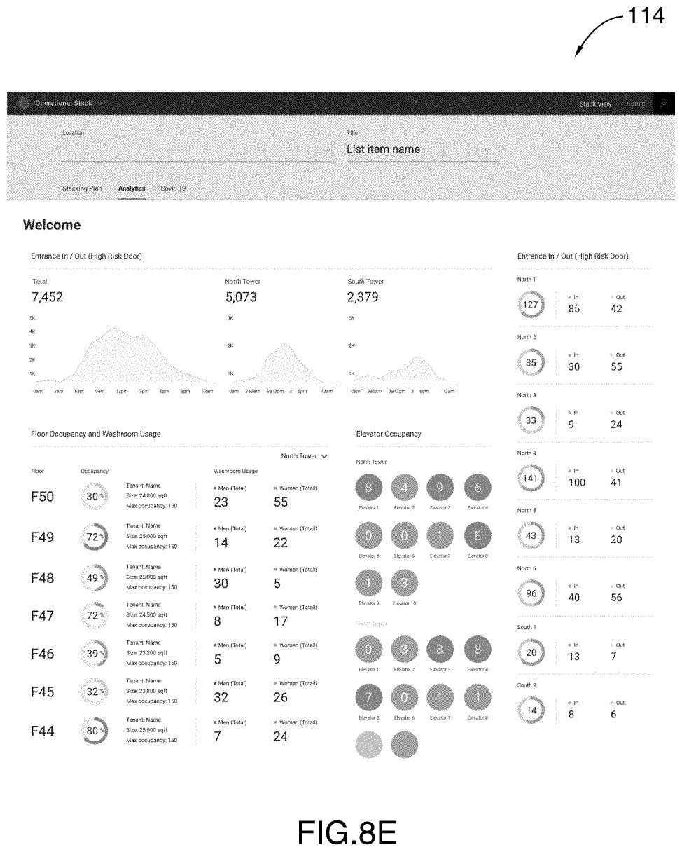

In accordance with a preferred embodiment, FIG. 8A depicts a classroom application of the present invention. An image 110a (including a measured area) of the classroom is shown. The occupancy data layer 110e indicates that one of the classroom seats is occupied (i.e., anonymized information from an occupancy sensor so that information on the identity of the occupant does not need to be shared with other parties). A body data layer 110k may also be included that provides biometric information on occupant(s) (e.g., heart rate/breathing rate) to monitor health and/or stress level. A performance data layer 110m may also be included that provides education performance information on occupant(s). A cleaning data layer (provided as a work order data layer 110h) may also be included that provides cleaning information on the space used by the occupant(s). A device identification and location data layer 110e may also be included that identifies the device associated with the occupant(s) and the location of the occupant(s). A relationship between each of the one or more data layers 110 (e.g., heart rate/breathing rate and education performance) can be determined using the relationship algorithm 801 and stored as relationship data 130.

In accordance with a preferred embodiment, the body data layer 110k may be used, for example, in an immigration line to identify stress and anxiety patterns in an individual to establish a base line. The body data for that individual may be applied in the future to determine whether the level of stress and anxiety being experienced by the individual is considered a base line response or something other than a base line response which may indicate a need for further investigation.

In accordance with a preferred embodiment, FIG. 8B depicts a floorplan occupancy application of the present invention. A map 110a is shown. The occupancy data layer 110e indicates the number of occupants in the floorplan (the maximum occupancy and the percent of maximum occupancy in real-time, for example) as well as the number of occupants that have entered and exited the floorplan in a given time period (e.g., today). The location data layer may also be included to provide the location of the occupant(s) and, for example, provide an alert 128 (e.g., social distancing alert) if the number of occupants in a predetermined proximity exceed a threshold. A relationship between each of the one or more data layers (e.g., occupancy and location of occupants) can be determined using the relationship algorithm 801 and stored as relationship data 130.

In accordance with a preferred embodiment, FIG. 8C depicts an elevator status application of the present invention. A map 110a is shown. The elevator data layer indicates the average elevator occupancy, the average weekly downtime (i.e., a report 114), alert notices 128 (e.g. elevator outage alert). The occupancy data layer 110e indicates the number of people using the elevator to reach the floor depicted by the map 110a. A relationship between each of the one or more data layers (e.g., occupancy and elevator outage alert) can be determined using the relationship algorithm 801 and stored as relationship data 130.

In accordance with a preferred embodiment, FIG. 8D depicts a noise application of the present invention. A map 110a is shown. The occupancy data layer 110e indicates the current floor occupancy over time, the maximum occupancy, the size of the floorplan, the percent occupied. The noise data layer may also be included to provide the noise levels (dB) in various locations of the floorplan (e.g., associated with the location of one or more occupants). A relationship between each of the one or more data layers (e.g., occupancy and noise) can be determined using the relationship algorithm 801 and stored as relationship data 130.

In accordance with a preferred embodiment, FIG. 8E depicts a report 114 on occupancy on various floors and locations including, number of occupants entering and exiting a location over time, floor occupancy and washroom usage, and elevator occupancy. This information may be used in association with a business case.

Processors:

Preferably, the processors 202, 302, 402—i.e., the client processor 202, the management processor 302, and/or the administrator processor 402—are operatively encoded with one or more algorithms 801, 802, 803, 804 (shown schematically in FIGS. 5 and 6 as being stored in the memory 250, 350, 450 associated with the client subsystem 200, the management subsystem 300 and/or the administrator subsystem 400) which provide the processors 202, 302, 402 with relationship logic 801, data zone logic 802, and/or data layer logic 803. Preferably, the algorithms 801, 802, 803 enable the processors 202, 302, 402 to assess the data 110, 120, 122, 124, 130 received from the client processor 202 and/or the management processor 302 as well as any additional data 110 that may be associated with the various data layers 110a, 110b, 110c, 110d, 110e, 110f, 110g, 110h, 110i, 110j, 110k, 110m and/or the data zones 112.

In a preferred embodiment, each of the client subsystem 200, the management subsystem 300 and the administrator subsystem 400 may be associated with one or more processors, one or more computer readable media (e.g., an onboard processor-readable memory, for example, a read-only memory (ROM) or dynamic random access memory (DRAM) which communicate with each other via a bus) local to the processor, one or more network interfaces (preferably including transmitter-receiver functions and adapted for use with a network), one or more databases, one or more input-output components, and one or more buses.

The processor may be a microcontroller, an embedded processor, a field programmable gate array (“FPGA”) or another suitable microprocessor. Preferably, the processor is operatively encoded with one or more algorithms stored in the memory, which provide the processor with, for example, one or more algorithms to provide logic to enable the processor to assess data 110a, 110b, 110c, 110d, 110e, 110f, 110g, 110h, 110i, 110j, 110k, 110m as well as any additional data that may be associated with the data layers 110 and/or the data zones 112. In operation, the processors 202, 302, 402 receive data from the one or more: sensors 116; equipment 118; databases 204, 304, 404; input-output devices 126; and/or memory 250, 350, 450 which may be on demand and/or at a predetermined time or time intervals (to, for example, drive real-time analysis of the relationship between data layers 110). The data 120, 122, 124 is analyzed by the execution of certain algorithms (e.g., relationship algorithm 801) via the processor(s) 202, 302, 402 to generate relationship data 130, that includes instructions 110h, alerts 128 and/or reports 114.

The system 100 includes various algorithms (e.g., relationship algorithm 801, data zone algorithm 802, data layer algorithm 803, etc.), which causes the processor(s) 202, 302, 402 to perform any one or more of the instructions discussed herein. The system 100 may include additional or different components, some of which may be optional and not necessary to provide aspects of the present disclosure. The system 100, as shown in FIGS. 5 and 6, may be connected to other computing devices in a LAN, an intranet, an extranet, or the Internet. The system 100 may operate in the capacity of a server or a client computing device in client-server network environment, or as a peer computing device in a peer-to-peer (or distributed) network environment. Further, the term “processor” shall be taken to include any collection of computing devices that individually or jointly execute a set (or multiple sets) of instructions to perform any one or more of the methodologies discussed herein.

The system 100 may further include a network interface device, one or more sensors 116, one or more pieces of equipment 118, and one or more input-output devices 126 (e.g., a keyboard and touch screen).

In an embodiment of the present invention, the system 100 depicted in FIGS. 5 and 6 may be entirely or partially replicated remotely (e.g., cloud computing). Preferably, the remote system includes one or more remote processors capable of at least partially executing the method such that data 110, 120, 122, 124, 130 may be uploaded to the client subsystem 200, the management subsystem 300, and/or the administrator subsystem 400 and the data 110, 120, 122, 124, 130 analyzed.

The computer readable medium 1100 stores executable instructions (i.e., algorithms 801, 802, 803, 804) which, upon execution, analyzes data 110, 120, 122, 124, 130 preferably received from the one or more sensors 116, the one or more pieces of equipment 118, the input-output components 126 and/or the database(s) 204, 304, 404. The executable instructions provide logic 801, 802, 803, 804 to the processor(s) 202, 302, 402 for the performance of steps and/or to provide functionality as otherwise described above and elsewhere herein. The processor(s) 202, 302, 402 encoded by the computer readable medium 1100 are such as to perform an analysis on the data 110, 120, 122, 124, 130 to, for example, generate predetermined and/or desired information. Thus, according to the invention, the computer readable medium 1100 facilitates the use of the processor(s) 202, 302, 402 to operatively facilitate the analysis of the data 110, 120, 122, 124, 130. In alternate embodiments, the algorithms 801, 802 803, 804 may be transmitted or received over the network 500 via the network interface device.

Thus, the system 100, method 1000, and computer readable medium 1100 operatively facilitate the determination of relationships between data layers, integration of data and/or workflow automation across data layers and/or data zones.

The database(s) 204, 304, 404 include, and are regularly updated with, the data 110, 120, 122, 124, 130. The database(s) 204, 304, 404 may be located behind a firewall relative to the network. Persons of ordinary skill in the art will appreciate that references herein to the database(s) 204, 304, 404 may include, as appropriate, references to: (i) a single database located local to the server or administrator processor 402; (ii) a single database located at a facility (e.g., remote to the server or administrator processor 402); and/or (iii) one or more congruent and/or distributed databases such as, for example, also including one or more sets of congruently inter-related databases—possibly distributed across multiple facilities.

Method:

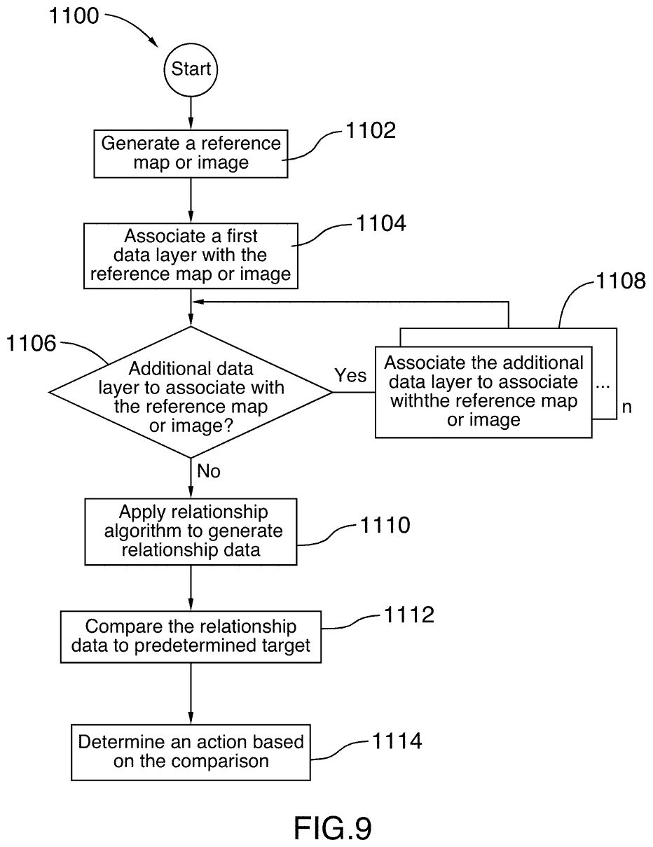

FIG. 9 depicts the steps of a method 1000 to integrate data from different databases apply relationships identified from the integration with respect to a predetermined space and/or image using client data 120, management data 122 and/or administrator data 124. In the description of the method 1100 which follow, the same reference numerals are used as those which are used, above, with reference to the system 100. Method 1000 is suitable for use with the system 100 described above and shown in FIG. 9, but it is not so limited.

As shown in FIG. 9, the method 1000 includes the following steps, among others: a start step; a step 1102 of generating a reference map or image; a step 1104 of associating a first data layer with the reference map or image 1104; a step 1106 of querying if an additional n data layers should be associated with the reference map or image. If the query is answered in the affirmative (i.e., if an additional n data layer should be associated with the reference map or image), a step 1108 of associating the additional data layer with the reference map or image. If answered in the negative, the method proceeds to a step 1110 of applying a relationship algorithm to the n+1 data layers to generate relationship data between the n+1 data layers and the reference map or image. A step 1112 of comparing the relationship data to one or more predetermined targets and a step 1114 of determining an action based on the comparison. In preferable embodiments, the action may be determined by a comparison of the relationship data against a target or reference value for a desired relationship (e.g., the occupancy of a room on a map should not exceed a certain predetermined value). In accordance with the present method, “n” may result in two or more data layers associated with the reference map or image. In accordance with the present method, the relationship data includes one or more relationships between the data layers.

It will be appreciated that, according to the method 1000, the client data 120, the management data 122 and/or the administrator data 124 is collected by the sensors 116, equipment 118 and/or the input-output device 126 (collectively, the “data devices”). The processors 202, 302, 402 are used to automatically: collect the data 120, 122, 124; combine and/or reconcile the data 120, 122, 124 against one another to generate relationship data 130; compare the relationship data 130 against predetermined reference data, as applicable, and/or predetermined target value(s) for the data 130; and generate a report 114 which includes the collected, combined, reconciled and/or compared relationship data 130, preferably presented to the administrator and/or management. Thus, according to the invention, the method 1000 operatively facilitates the analysis of data 120, 122, 124 to generate one or more relationships between the data 120, 122, 124 and the map 110a or image 110a and determine an action based on the one or more relationships.

The computer readable medium 1100, shown in FIG. 6, stores executable instructions which, upon execution, analyzes data associated with client, management and/or administrator. The executable instructions include processor instructions 801, 802 803, 804 for the processors 202, 302, 402 to, according to a preferred embodiment of the invention, perform the aforesaid method 1000 and perform steps and provide functionality as otherwise described above and elsewhere herein. The processors 202, 302, 402 encoded by the computer readable medium 1100 are such as to receive data (including client data 120, management data 122, administrator data 124 and relationship data 130), perform an analysis on the data 130, generate a report 114 based on the analysis, and transmit the data 120, 122, 124, 130 to the database 204, 304, 404. Thus, according to the invention, the computer readable medium 1100 facilitates use of the processors 202, 302, 402 to operatively facilitate the determination of actions (or business cases) based on the one or more relationships identified between two or more sets of data associated with a reference map or image.

The present disclosure may be described herein with reference to system architecture, block diagrams and flowchart illustrations of methods, and computer program products according to various aspects of the present disclosure. It may be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It may also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In this disclosure, a number of terms and abbreviations may be used. The following definitions and descriptions of such terms and abbreviations are provided in greater detail.

It may be further generally understood by a person skilled in the relevant art that the term “downloading” refers to receiving datum or data to a local system from a remote system or to initiate such a datum or data transfer. Examples of a remote systems or clients from which a download might be performed include, but are not limited to, web servers, FTP servers, email servers, or other similar systems. A download can mean either any file that may be offered for downloading or that has been downloaded, or the process of receiving such a file. A person skilled in the relevant art may understand the inverse operation, namely sending of data from a local system to a remote system may be referred to as “uploading”. The data and/or information used according to the present invention may be updated constantly, hourly, daily, weekly, monthly, yearly, etc. depending on the type of data and/or the level of importance inherent in, and/or assigned to, each type of data. Some of the data may preferably be downloaded from the Internet, by satellite networks or other wired or wireless networks.

Elements of the present invention may be implemented with computer systems which are well known in the art. In general, computers include a central processor, system memory, and a system bus that couples various system components including the system memory to the central processor. A system bus may be any of several types of bus structures including a memory bus or memory controller, a peripheral bus, and a local bus using any of a variety of bus architectures. The structure of a system memory may be well known to those skilled in the art and may include a basic input/output system (“BIOS”) stored in a read only memory (“ROM”) and one or more program modules such as operating systems, application programs and program data stored in random access memory (“RAM”). Computers may also include a variety of interface units and drives for reading and writing data. A user of the system can interact with the computer using a variety of input devices, all of which are known to a person skilled in the relevant art.

One skilled in the relevant art would appreciate that the device connections mentioned herein are for illustration purposes only and that any number of possible configurations and selection of peripheral devices could be coupled to the computer system.

Computers can operate in a networked environment using logical connections to one or more remote computers or other devices, such as a server, a router, a network personal computer, a peer device or other common network node, a wireless telephone or wireless personal digital assistant. The computer of the present invention may include a network interface that couples the system bus to a local area network (“LAN”). Networking environments are commonplace in offices, enterprise-wide computer networks and home computer systems. A wide area network (“WAN”), such as the Internet, can also be accessed by a computer, a mobile device, or the device.

It may be appreciated that the type of connections contemplated herein are exemplary and other ways of establishing a communications link between computers may be used in accordance with the present invention, including, for example, mobile devices and networks. The existence of any of various well-known protocols, such as TCP/IP, Frame Relay, Ethernet, FTP, HTTP and the like, may be presumed, and computer can be operated in a client-server configuration to permit a user to retrieve and send data to and from a web-based server. Furthermore, any of various conventional web browsers can be used to display and manipulate data in association with a web-based application. In addition, any of various mobile applications (including but not limited to iOS and Android applications) can be used to display and manipulate data.

The operation of the network ready device (i.e., a mobile device) may be controlled by a variety of different program modules, engines, etc. Examples of program modules are routines, algorithms, programs, objects, components, data structures, etc. that perform particular tasks or implement particular abstract data types. It may be understood that the present invention may also be practiced with other computer system configurations, including multiprocessor systems, microprocessor-based or programmable consumer electronics, network PCS, personal computers, minicomputers, mainframe computers, and the like. Furthermore, the invention may also be practiced in distributed computing environments where tasks are performed by remote processing devices that are linked through a communications network. In a distributed computing environment, program modules may be located in both local and remote memory storage devices.

Embodiments of the present invention can be implemented by a software program for processing data through a computer system. It may be understood by a person skilled in the relevant art that the computer system can be a personal computer, mobile device, notebook computer, server computer, mainframe, networked computer (e.g., router), workstation, processor onboard the device and the like. In one embodiment, the computer system includes a processor coupled to a bus and memory storage coupled to the bus. The memory storage can be volatile or non-volatile (i.e., transitory or non-transitory) and can include removable storage media. The computer can also include a display, provision for data input and output, etc. as may be understood by a person skilled in the relevant art.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following description, it is appreciated that throughout the present invention, references utilizing terms such as “receiving”, “creating”, “providing”, “communicating” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

The present invention is contemplated for use in association with one or more cooperating environments, to afford increased functionality and/or advantageous utilities in association with same. The invention, however, is not so limited.

Naturally, in view of the teachings and disclosures herein, persons having ordinary skill in the art may appreciate that alternate designs and/or embodiments of the invention may be possible (e.g., with substitution of one or more steps, algorithms, processes, features, structures, parts, components, modules, utilities, etc. for others, with alternate relations and/or configurations of steps, algorithms, processes, features, structures, parts, components, modules, utilities, etc.).

Although some of the steps, algorithms, processes, features, structures, parts, components, modules, utilities, relations, configurations, etc. according to the invention are not specifically referenced in association with one another, they may be used, and/or adapted for use, in association therewith.

One or more of the disclosed steps, algorithms, processes, features, structures, parts, components, modules, utilities, relations, configurations, and the like may be implemented in and/or by the invention, on their own, and/or without reference, regard or likewise implementation of one or more of the other disclosed steps, algorithms, processes, features, structures, parts, components, modules, utilities, relations, configurations, and the like, in various permutations and combinations, as may be readily apparent to those skilled in the art.

While computer-readable storage medium may be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

It may generally be understood by a person skilled in the relevant art that the term “cloud computing” is an information technology model that facilitates ubiquitous access to shared pools of configurable system resources and higher-level services that can be provisioned with minimal management effort, usually over the Internet. Third-party clouds preferably enable organizations to focus on their core businesses instead of allocating resources on computer infrastructure and maintenance.

The methods, components, and features described herein may be implemented by discrete hardware components or may be integrated in the functionality of other hardware components such as ASICS, FPGAs, DSPs, or similar devices. In addition, the methods, components, and features may be implemented by firmware modules or functional circuitry within hardware devices. Further, the methods, components, and features may be implemented in any combination of hardware devices and software components, or only in software.

In the present description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

The present disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions.

The foregoing description has been presented for the purpose of illustration and maybe not intended to be exhaustive or to limit the invention to the precise form disclosed. Other modifications, variations and alterations are possible in light of the above teaching and may be apparent to those skilled in the art, and may be used in the design and manufacture of other embodiments according to the present invention without departing from the spirit and scope of the invention. It may be intended the scope of the invention be limited not by this description but only by the claims forming a part of this application and/or any patent issuing therefrom.

1. A system for data integration across one or more data sets associated with a reference image from one or more stakeholders, wherein the system comprises:
(a) one or more processors operative to: (i) electronically receive the one or more data sets associated with the reference image; (ii) generate one or more data layers for each of the one or more data sets; (iii) combine and/or reconcile the one or more data layers associated with the reference image to generate relationship data; and (iv) compare the reference data with one or more predetermined targets to determine an action associated with the reference image; and
(b) one or more databases to electronically store the one or more data sets, the one or more data layers, the relationship data and the action;
wherein the system is operative to facilitate the determination of relationships between the data sets from the one or more stakeholders.

2. A method for data integration across one or more data sets associated with a reference image from one or more stakeholders, wherein the method comprises the steps of:
(a) operating one or more processors to electronically receive the one or more data sets associated with the reference image to: (i) generate one or more data layers for each of the one or more data sets; (ii) combine and/or reconcile the one or more data layers associated with the reference image to generate relationship data; and (iii) compare the relationship data with one or more predetermined targets to determine an action associated with the reference image; and
(b) electronically store the one or more data sets, the one or more data layers, the relationship data and the action in one or more databases;
wherein the relationship data and the reconciled data layers thereof are configured to determine relationships between the data sets from the one or more stakeholders.

3. A non-transient computer readable medium on which is physically stored executable instructions for use in association with data integration across one or more data sets associated with a reference image from one or more stakeholders, wherein the executable instructions comprise processor instructions to automatically:
(a) collect and/or electronically communicate one or more data sets associated with the reference image to one or more processors;
(b) generate one or more data layers for each of the one or more data sets;
(c) combine and/or reconcile the one or more data layers associated with the reference image to generate relationship data;
(d) compare the relationship data with one or more predetermined targets to determine an action associated with the reference image; and
(e) electronically store the relationship data, the one or more data layers, and the action in one or more databases;
wherein the relationship data and the reconciled data sets thereof are for use in determining relationships between the data sets from the one or more stakeholders.
